(19) United States
(12) Patent Application Publication
(10) Pub. No.: US 2013/0036167 A1
(43) Pub. Date: Feb. 7, 2013

(54) AUTOMATIC SYNCHRONIZATION OF CLIPBOARDS

(71) Applicants: Philippe Bazot, Vence (FR); Jacques Cresp, Saint Jeannet (FR); Fabrice Livigni, Montauroux (FR); Olivier Oudot, Vallauris (FR); Richard Sert, Frejus (FR); Alain Siles, Vence (FR); Joel Viale, Vence (FR)

(72) Inventors: Philippe Bazot, Vence (FR); Jacques Cresp, Saint Jeannet (FR); Fabrice Livigni, Montauroux (FR); Olivier Oudot, Vallauris (FR); Richard Sert, Frejus (FR); Alain Siles, Vence (FR); Joel Viale, Vence (FR)

(73) Assignee: INTERNATIONAL BUSINESS MACHINES CORPORATION, Armonk, NY (US)

(21) Appl. No.: 13/225,622

(22) Filed: Sep. 6, 2011

(30) Foreign Application Priority Data
Aug. 5, 2011 (EP) 11290362.0

(51) Int. Cl. G06F 15/16

(52) U.S. Cl. 709/204

(57) ABSTRACT

A computer-implemented method and computer program for automatically synchronizing clipboards of multiple devices. The computer-implemented method includes: pairing at least two devices via a Bluetooth connection; providing a information on a sharing clipboard of a first device; automatically broadcasting, in response to the providing, the information from the sharing clipboard of the first device to a sharing clipboard of a second device; and pasting the information on the sharing clipboard of the second device.

### TECHNICAL FIELD

The disclosure relates generally to automatically synchronizing clipboards, and more particularly, to a system of automatically synchronizing clipboards of multiple devices via a Bluetooth connection.

### BACKGROUND ART

Currently, users on different devices are unable to share information using a copy and paste function without an Internet Protocol (IP) network connection. In order to share information, users must have an IP network connection, and most likely, a third party to provide a sharing network. One example of such an “internet clipboard” may be found at http://cllp.net/.

However, if a user does not have an IP network connection, the user will not be able to access the shared information. Further, as with the internet clipboard example above, the shared information can be accessed by anyone with the Uniform Resource Locator (URL) for the shared information. Therefore, proprietary information cannot be targeted to one specific user on a specific device. Additionally, users cannot automatically synchronize the clipboards of their respective devices. A user must access the network, copy the shared information, and then paste the information on the device.

### SUMMARY OF THE INVENTION

In view of the problems and objects set forth above, the present invention provides automatic synchronization of clipboards of multiple devices. A method and computer program are provided that are capable of automatically synchronizing clipboards of multiple devices using a Bluetooth connection.

A first aspect of the invention provides a computer-implemented method of automatically synchronizing clipboards of multiple devices, the method comprising: pairing at least two devices via a Bluetooth connection; providing information on a sharing clipboard of a first device; automatically broadcasting, in response to the providing, the information from the sharing clipboard of the first device to a sharing clipboard of a second device; and pasting the information on the sharing clipboard of the second device.

A second aspect of the invention provides a device, comprising: a Bluetooth connector for pairing with at least one other device; a sharing clipboard for a user to provide information to be shared with the at least one other device; and an application for automatically broadcasting the information to the at least one other device.

A third aspect of the invention provides a computer program comprising program code embodied in at least one computer-readable medium, which when executed, enables a computer system to implement a method of automatically synchronizing clipboards of multiple devices, the method comprising: pairing at least two devices via a Bluetooth connection; providing a information on a sharing clipboard of a first device; automatically broadcasting, in response to the providing, the information from the sharing clipboard of the first device to a sharing clipboard of a second device; and pasting the information on the sharing clipboard of the second device.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows a system of multiple devices according to embodiments of the invention.

FIG. 2 shows an illustrative environment of a device according to embodiments of the invention.

FIG. 3 shows a flow diagram of a computer-implemented method of automatically synchronizing multiple devices according to embodiments of the invention.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide for automatically synchronizing clipboards of multiple devices. As used herein, unless otherwise noted, the term “set” means one or more (i.e., at least one) and the phrase “any solution” means any now known or later developed solution.

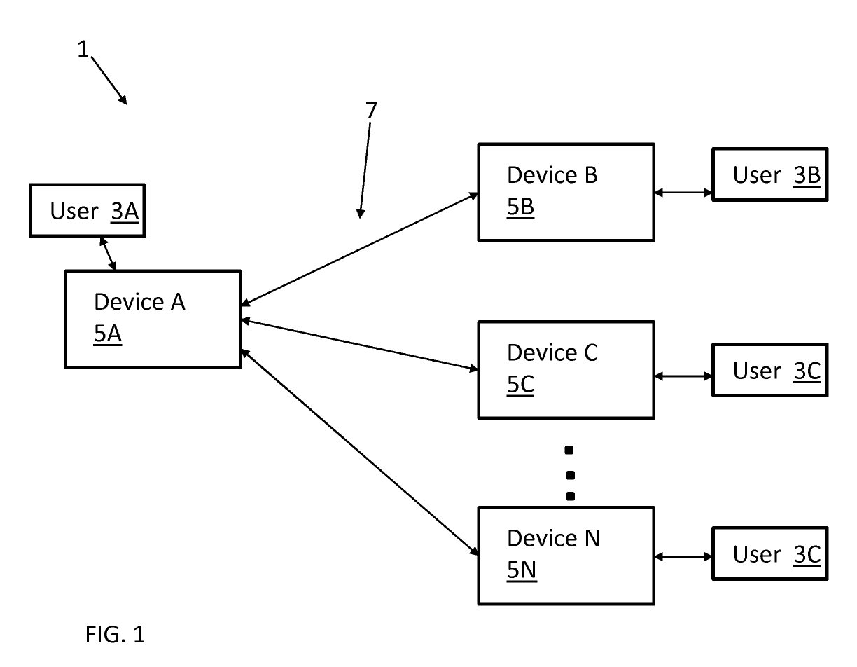

Turning to the drawings, FIG. 1 shows a system 1 of multiple devices 5A, 5B, 5C, . . . , 5N. The system 1 may include any number (N) of devices and each device may be controlled by a respective user 3A, 3B, 3C, . . . , 3N. Each device may be any now known or later developed device that supports Bluetooth technology, such as, but not limited to a computer, a mobile phone, or a smartphone. As known, Bluetooth is an open wireless technology standard for exchanging data over distances using short wavelength radio transmissions. Devices supporting Bluetooth technology may be paired, such as devices 5A, 5B, 5C, . . . , 5N, which are paired through a Bluetooth connection 7. This creates personal area networks (PANs) with high levels of security between the paired devices.

Devices 5A, 5B, 5C, . . . , 5N may be paired via a Bluetooth connection 7 using any now known or later developed pairing mechanism. For example, Bluetooth connection 7 may be made through legacy pairing, where each device must enter an identical PIN code in order to be paired. Other examples include simple secure pairing (SSP), where a device may confirm or deny to pair or connect with another device without user interaction, or a device providing a name of the other device in order to connect to the other device.

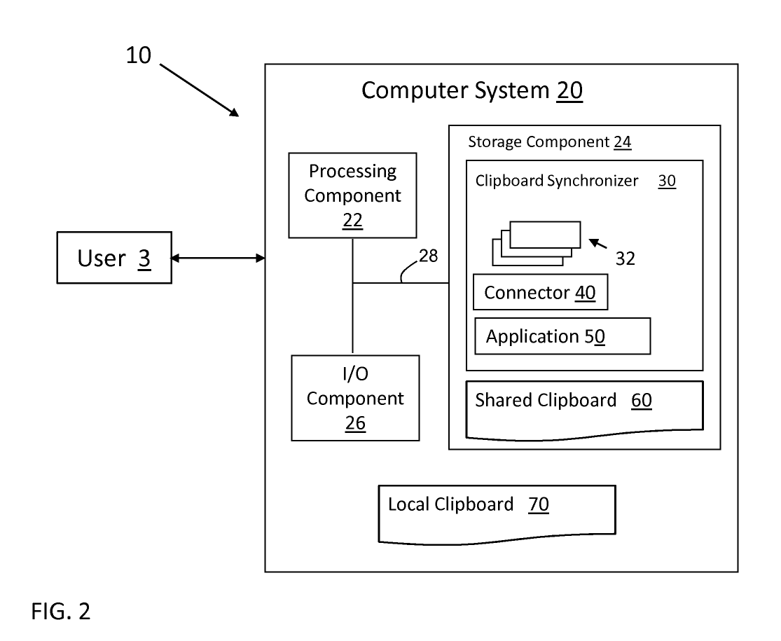

Turning now to FIG. 2, an illustrative environment 10 for automatically synchronizing clipboards of multiple devices 5A, 5B, 5C, . . . , 5N (FIG. 1) according to embodiments of the invention is shown. To this extent, environment 10 includes a computer system 20 that can perform a process described herein in order to automatically synchronize clipboards of multiple devices 5A, 5B, 5C, . . . , 5N (FIG. 1). In particular, computer system 20 is shown including a clipboard synchronizer program 30, which makes computer system 20 operable to automatically synchronize clipboards of multiple devices 5A, 5B, 5C, . . . , 5N (FIG. 1) by performing a process described herein. It is understood that each device 5A, 5B, 5C, . . . , 5N (FIG. 1) includes a computer system 20, as described herein.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as clipboard synchronizer program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user 12 to interact with computer system 20 and/or one or more communications devices to enable a system user 12 to communicate with computer system 20 using any type of communications link. To this extent, clipboard synchronizer program 30 can manage a set of interfaces (e.g., graphical user interface(s), application program interface, and/or the like) that enable human and/or system users 12 to interact with clipboard synchronizer program 30. Further, clipboard synchronizer program 30 can manage (e.g., store, retrieve, create, manipulate, organize, present, etc.) the data, such as shared clipboard data 40, using any solution.

In any event, computer system 20 can comprise one or more general purpose computing articles of manufacture (e.g., computing devices) capable of executing program code, such as clipboard synchronizer program 30, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, clipboard synchronizer program 30 can be embodied as any combination of system software and/or application software.

Further, clipboard synchronizer program 30 can be implemented using a set of modules 32. In this case, a module 32 can enable computer system 20 to perform a set of tasks used by clipboard synchronizer program 30, and can be separately developed and/or implemented apart from other portions of clipboard synchronizer program 30. As used herein, the term “component” means any configuration of hardware, with or without software, which implements the functionality described in conjunction therewith using any solution, while the term “module” means program code that enables a computer system 20 to implement the actions described in conjunction therewith using any solution. When fixed in a storage component 24 of a computer system 20 that includes a processing component 22, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of clipboard synchronizer program 30 fixed thereon (e.g., one or more modules 32). However, it is understood that computer system 20 and clipboard synchronizer program 30 are only representative of various possible equivalent computer systems that may perform a process described herein. To this extent, in other embodiments, the functionality provided by computer system 20 and clipboard synchronizer program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, clipboard synchronizer program 30 enables computer system 20 to automatically synchronize clipboards of multiple devices 5A, 5B, 5C, . . . , 5N (FIG. 1). Device 5A will be used as an example to describe the details of clipboard synchronizer program 30; however, it is understood that these teachings can be applied to any device in system 1. To this extent, clipboard synchronizer program 30 (of device 5A) includes a connector 40 for enabling a Bluetooth connection 7 (FIG. 1) with the connector 40 of another device (i.e., devices 5B, 5C, . . . , 5N). As described above, Bluetooth connection 7 to pair device 5A with other devices (i.e., devices 5B, 5C, . . . , 5N) may be through any now known or later developed pairing mechanisms.

Clipboard synchronizer program 30 on device 5A may include an application 50 that captures a information stored on a shared clipboard 60. The information stored on the shared clipboard 60 may be provided by user 3A in order to share the information with other devices (i.e., devices 5B, 5C, . . . , 5N). Application 50 automatically broadcasts, in response to the information being stored on the shared clipboard 60, the information stored on the shared clipboard 60 to an application 50 on another device (i.e., devices 5B, 5C, . . . , 5N).

As described above, the broadcasting is through the Bluetooth connection 7. Application 50 automatically pastes the plurality information that is received to the shared clipboard 60. For example, if application 50 on device 5A receives a information from application 50 on device 5B, application 50 on device 5A will paste the information into the shared clipboard 60.

Devices 5A, 5B, 5C, . . . , 5N may choose to not share information with any other device that it is paired with. Each of the multiple devices 5A, 5B, 5C, . . . , 5N may include a local clipboard 70. Application 50 of each device does not have access to local clipboard 70 of other devices, and the information stored on local clipboard 70 will not be broadcasted, through Bluetooth connection 7, to the other devices.

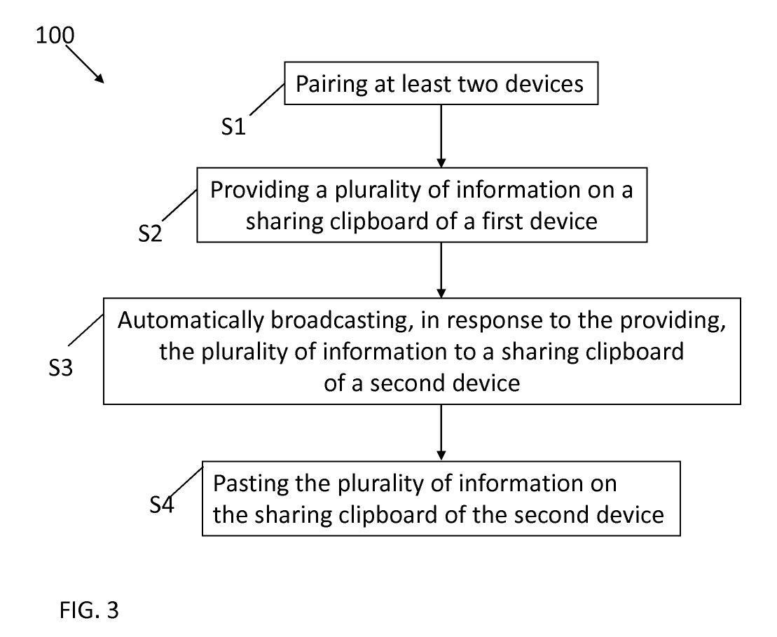

Turning now to FIG. 3, a flow diagram 100 of a computer-implemented method of automatically synchronizing multiple devices (i.e., devices 5A, 5B, 5C, . . . , 5N) according to embodiments of the invention is shown. At step S1, at least two devices (for example, device 5A and device 5B) are paired via a Bluetooth connection 7. Device 5A and device 5B may be paired using any now known or later developed pairing mechanism. For example, device 5A may pair with device 5B by providing the Bluetooth network name of device 5B.

At step S2, a user 3A (FIG. 1) provides a information on the shared clipboard 60 of device 5A. In response to the providing of the information, at step S3, an application 50 on device 5A automatically captures the information on the shared clipboard 60 and automatically broadcast the information to a shared clipboard 60 on device 5B. At step S4, application 50 on device 5B automatically pastes the information on the sharing clipboard 60 of device 5B. As such, the shared clipboards 60 of devices 5A and 5B will automatically be synchronized via a Bluetooth connection 7. User 3B of device 5B will have access to the information from user 3A of device 5A, without an internet or IP network connection.

While shown and described herein as a method and system for automatically synchronizing clipboards of multiple devices, it is understood that aspects of the invention further provide various alternative embodiments. For example, in one embodiment, the invention provides a computer program fixed in at least one computer-readable medium, which when executed, enables a computer system to automatically synchronizing clipboards of multiple devices. To this extent, the computer-readable medium includes program code, such as clipboard synchronizer program 30 (FIG. 2), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as clipboard synchronizer program 30 (FIG. 2), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for automatically synchronizing clipboards of multiple devices. In this case, a computer system, such as computer system 20 (FIG. 2), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

It is understood that aspects of the invention can be implemented as part of a business method that performs a process described herein on a subscription, advertising, and/or fee basis. That is, a service provider could offer to automatically synchronizing clipboards of multiple devices as described herein. In this case, the service provider can manage (e.g., create, maintain, support, etc.) a computer system, such as computer system 20 (FIG. 2), that performs a process described herein for one or more customers. In return, the service provider can receive payment from the customer(s) under a subscription and/or fee agreement, receive payment from the sale of advertising to one or more third parties, and/or the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer-implemented method of automatically synchronizing clipboards of multiple devices, the method comprising:
pairing at least two devices via a Bluetooth connection;
providing a information on a sharing clipboard of a first device;
automatically broadcasting, in response to the providing, the information from the sharing clipboard of the first device to a sharing clipboard of a second device; and
pasting the information on the sharing clipboard of the second device.

2. The computer-implemented method of claim 1, wherein each of the multiple devices is one of: a computer; a mobile phone, or a smartphone.

3. The computer-implemented method of claim 1, wherein each of the multiple devices includes a graphical user interface to view the sharing clipboard.

4. The computer-implemented method of claim 1, wherein an application on the first device captures the information and automatically broadcasts the information from the sharing clipboard of the first device to the sharing clipboard of the second device.

5. The computer-implemented method of claim 4, wherein an application on the second device receives the information from the application on the first device and pastes the information on the sharing clipboard of the second device.

6. The computer-implemented method of claim 1, wherein pairing the at least two devices via the Bluetooth connection further includes the first device providing a name for the second device.

7. The computer-implemented method of claim 1, wherein each of the multiple devices includes a local clipboard.

8. A device, comprising:
a Bluetooth connector for pairing with at least one other device;
a sharing clipboard for a user to provide information to be shared with the at least one other device; and
an application for automatically broadcasting the information to the at least one other device.

9. The device of claim 8, wherein each of the device and the at least one other device is one of: a computer, a mobile phone, or a smartphone.

10. The device of claim 8, wherein the device includes a graphical user interface to view the sharing clipboard.

11. The device of claim 8, wherein the application automatically captures the information from the sharing clipboard once the user provides the information.

12. The device of claim 8, wherein the Bluetooth connector of the device pairs with a Bluetooth connector of the at least one other device using a name of the at least one other device.

13. The device of claim 8, wherein the device includes a local clipboard.

14. A computer program comprising program code embodied in at least one computer-readable medium, which when executed, enables a computer system to implement a method of automatically synchronizing clipboards of multiple devices, the method comprising:
pairing at least two devices via a Bluetooth connection;
providing a information on a sharing clipboard of a first device;
automatically broadcasting, in response to the providing, the information from the sharing clipboard of the first device to a sharing clipboard of a second device; and
pasting the information on the sharing clipboard of the second device.

15. The computer program of claim 13, wherein each of the multiple devices is one of: a computer; a mobile phone, or a smartphone.

16. The computer program of claim 13, wherein each of the multiple devices includes a graphical user interface.

17. The computer program of claim 13, wherein an application on the first device captures the information and automatically broadcasts the information from the sharing clipboard of the first device to the sharing clipboard of the second device.

18. The computer program of claim 16, wherein an application on the second device receives the information from the application on the first device and pastes the information on the sharing clipboard of the second device.

19. The computer program of claim 13, wherein pairing the at least two devices via the Bluetooth connection further includes the first device providing a name for the second device.

20. The computer program of claim 13, wherein each of the multiple devices includes a local clipboard.
